(19) United States
(12) Patent Application Publication
(10) Pub. No.: US 2026/0178818 A1
(43) Pub. Date: Jun. 25, 2026

(54) SYSTEMS AND METHODS FOR COMPREHENSIVE WRITING ENHANCEMENT

(71) Applicant: Bold Limited, Hamilton (BM)

(72) Inventors: Shailesh KRISHNA, Ghaziabad (IN); Marie PANCHESSON, Denver, CO (US); Mohit Kumar GOEL, Greater Noida (IN); Sandeep GUPTA, Noida (IN); Nilesh SRIVASTAVA, Noida (IN); Ana DURAN, Seattle, WA (US)

(21) Appl. No.: 19/001,111

(22) Filed: Dec. 24, 2024

(51) Int. Cl. G06F 40/166; G06F 3/04842; G06F 40/247; G06Q 10/1053

(52) U.S. Cl. CPC G06F 40/166; G06F 3/04842; G06F 40/247; G06Q 10/1053

(57) ABSTRACT

Certain aspects of the disclosure provide systems and methods for providing comprehensive writing enhancement. Certain aspects include, receiving, from a document editing application, a user request to transform writing content and an indication of a modification for improving the writing content, receiving, from the document editing application, the writing content associated with the user request, generating, based on the user request and the writing content, a prompt for improving the writing content based on the indication of the modification, sending, to a language model, the prompt, receiving, from the language model, based on the prompt, transformed writing content, and sending, to the document editing application, the transformed writing content.

### INTRODUCTION

### Technical Field

Aspects of the present disclosure relate to improved systems and methods for providing comprehensive writing enhancement.

### BACKGROUND

Writing assistance tools are increasingly relied upon by users to enhance the quality of writing content. Writing assistance tools streamline an aspect of a writing process by applying or recommending modifications to improve target writing content. For example, a writing assistance tool for helping a user improve their resume may assist with ensuring grammar and punctuation is accurate. A different writing assistance tool may include features designed to provide style suggestions to improve the tone or professional quality of writing content. There is an opportunity to provide improved writing assistance tools to help users enhance the quality of writing content.

### SUMMARY

Certain aspects provide a method for enhancing writing content, the method including: receiving, from a document editing application, a user request to transform writing content and an indication of a modification for improving the writing content; receiving, from the document editing application, the writing content associated with the user request; generating, based on the user request and the writing content, a prompt for improving the writing content based on the indication of the modification; sending, to a language model, the prompt; receiving, from the language model, based on the prompt, transformed writing content; and sending, to the document editing application, the transformed writing content.

Other aspects provide a method for enhancing writing content, the method including: receiving, from a document editing application, a resume; receiving, from the document editing application, a user request to transform writing content, and an indication of a modification for improving the writing content; extracting, from the resume, the writing content; generating, based on the user request, the indication of the modification, and the extracted writing content, a prompt for improving the writing content based on the indication of the modification; sending the prompt to a language model; receiving, from the language model, based on the prompt, transformed writing content; and sending, to the document editing application, the transformed writing content.

Other aspects provide processing systems configured to perform the aforementioned method as well as those described herein; one or more memories comprising computer-executable instructions; and one or more processors configured to execute the computer-executable instructions causing the processing system to perform the aforementioned methods as well as those described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an illustrative environment for implementing a writing enhancement system according to one or more aspects shown and described herein.

FIG. 2 depicts an illustrative process implemented by a writing enhancement system for providing comprehensive writing enhancement according to one or more aspects shown and described herein.

FIG. 3 depicts an illustrative process implemented by a writing enhancement system to provide transformed writing content including linguistically enhanced work experience excerpts according to one or more aspects shown and described herein.

FIG. 4 depicts an illustrative process implemented by a writing enhancement system to provide transformed writing content including rephrased writing content according to one or more aspects shown and described herein.

FIG. 5 depicts an illustrative process implemented by a writing enhancement system to provide transformed writing content including enhanced work experience excerpts according to one or more aspects shown and described herein.

FIG. 6 depicts an illustrative process implemented by a writing enhancement system to provide transformed writing content including modified skills according to one or more aspects shown and described herein.

FIG. 7 depicts an illustrative process implemented by a writing enhancement system to provide transformed writing content including modified summaries according to one or more aspects shown and described herein.

FIG. 8 depicts an illustrative process implemented by a writing enhancement system to provide transformed writing content including modified sentences including inserted power words according to one or more aspects shown and described herein.

FIG. 9 depicts an illustrative process implemented by a writing enhancement system to provide transformed writing content having fewer redundancies according to one or more aspects shown and described herein.

FIG. 10 depicts an illustrative process implemented by a writing enhancement system to provide transformed writing content having reordered sections according to one or more aspects shown and described herein.

FIG. 11 depicts an illustrative process implemented by a writing enhancement system to provide transformed writing content having converted tenses according to one or more aspects shown and described herein.

FIG. 12 depicts an illustrative process implemented by a writing enhancement system to send transformed writing content and explainability statements to a user, and to receive corresponding user feedback according to one or more aspects shown and described herein.

FIG. 13 depicts an illustrative user interface of a document editing application employing a writing enhancement system to perform an illustrative processes of providing comprehensive writing enhancement according to one or more aspects shown and described herein.

FIG. 14 depicts an illustrative user interface of a document editing application employing a writing enhancement system to perform an illustrative processes of providing comprehensive writing enhancement according to one or more aspects shown and described herein.

FIG. 15 depicts an illustrative user interface of a document editing application employing a writing enhancement system to perform an illustrative processes of providing comprehensive writing enhancement according to one or more aspects shown and described herein.

FIG. 16 depicts an illustrative user interface of a document editing application employing a writing enhancement system to perform an illustrative processes of providing comprehensive writing enhancement according to one or more aspects shown and described herein.

FIG. 17 depicts an illustrative user interface of a document editing application employing a writing enhancement system to perform an illustrative processes of providing comprehensive writing enhancement according to one or more aspects shown and described herein.

FIG. 18 depicts an example method for providing a user with comprehensive writing enhancement according to one or more aspects shown and described herein.

FIG. 19 schematically depicts an example computing device for enabling a writing enhancement system for providing comprehensive writing enhancement for improving writing according to one or more aspects shown and described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for improved comprehensive writing enhancement. Aspects described herein generate transformed writing content based on a received user request corresponding to a given writing modification. Aspects described herein utilize specially programmed processing device(s) to generate specialized prompts for prompting language models to assist in generating transformed writing content based on writing modifications corresponding to a user request.

A language model (LM) is generally a type of machine learning model that is designed to understand, generate, and manipulate human language. More specifically, an LM is a probabilistic framework that determines the likelihood of a sequence of words or tokens. At its core, an LM attempts to predict the probability of the next word in a sentence given the preceding words. The model estimates these probabilities based on the patterns it learned during training. LMs are useful in natural language processing (NLP) and computational linguistics for performing a range of tasks involving human language.

LMs may be characterized by various components and capabilities. For example, an LM may include a vocabulary that defines the set of all possible words or tokens that the model can recognize and use. This includes common words, punctuation, and possibly domain-specific jargon. LMs may also consider a context, which refers to the preceding words in a sentence or sequence that the model uses to predict the next word. Modern LMs often incorporate extensive context windows, leveraging entire sentences or even paragraphs.

LMs may be implemented in various ways. For example, N-gram models predict the next word based on the previous N-1 words. Neural network-based LMs include Recurrent Neural Networks (RNNs), Long Short-Term Memory (LSTM) networks, and more Transformer models. These models capture more complex language patterns and context dependencies. The transformer architecture, introduced with models like BERT and GPT, utilizes self-attention mechanisms to handle long-range dependencies potentially more effectively than RNNs or LSTMs.

LMs are often trained using large corpora of text. The training process involves adjusting the model's parameters to minimize the difference between its predicted word probabilities and the actual word sequences in the training data. This is typically done via techniques like maximum likelihood estimation and gradient descent.

LMs have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

Thus, a language model is a sophisticated tool in NLP that analyzes and generates human language by understanding the probabilistic relationships between words and leveraging large datasets to learn these relationships. They form the backbone of many modern NLP applications, enabling machines to interpret, generate, and interact with human language.

Currently, writing unique and high-quality content can be a difficult and highly time-consuming process. Professional writing assistance is generally expensive and difficult to access for certain use cases, and moreover, is often subjective in nature. Additionally, a given writing process may present users with unique challenges depending upon the type of written content the user is attempting to create. For example, the writing process for writing resumes presents users with various challenges depending upon the industry in which a user is seeking employment, and the user's relevant experience. Accordingly, organizations that offer writing assistance tools for writing resumes strive to maximize customer satisfaction and retention by offering flexible writing assistance tools that directly address challenges of their prospective users.

However, writing certain types of documents, such as resumes, is complex and involves a diverse set of considerations. For example, the writing process for writing a resume is tailored to a specific user's industry and experience. Additionally, resumes are professional in nature, and could therefore benefit from the use of many different writing assistance tools having different corresponding writing improvement functionalities. For example, a user writing a resume may benefit from a first writing assistance tool that functions to improve conciseness in writing, a second writing assistance tool that functions to improve tense consistency in writing, as well as numerous other writing assistance tools having different functionalities. The large volume of available writing assistance functionalities can cause users to rely upon multiple individual specialized writing tools for providing different writing assistance functionality, resulting in increased time to address each property of writing to be improved within a given resume. Also, use of independent and uncoordinated writing tools may create interactions and artifacts during the writing process that reduce the effectiveness of such tools and the quality of the ultimate output.

Accordingly, a first technical problem arises with respect to how to provide a user with comprehensive writing enhancement functionality without requiring the use of numerous individual writing tools. Certain aspects described herein provide a technical solution to this technical problem by providing systems and methods that utilize an improved architecture, including specially configured processing device(s) for generating specialized prompts to enable language models to seamlessly assist with a wide variety of writing enhancement functionalities.

For example, systems and methods described herein leverage processing devices capable of generating a first prompt for leveraging a language model to assist with improving grammar and punctuation of writing content, and a second prompt for leveraging the language model to assist with modifying tense consistency of writing content. Accordingly, systems and methods described herein are configured to generate a variety of different specialized prompts corresponding to different writing improvement modifications based on a received user request and corresponding input writing content. Thus, systems and methods described herein overcome the constraints of current writing assistance tools having limited writing assistance functionality by utilizing improved architecture that provides the technical benefit of enabling a singular system to provide a wide variety of writing enhancement functionality.

Systems and methods described herein for improved techniques of providing comprehensive writing enhancement further provide for various technical benefits. As an example, aspects described herein include architecture for dynamically generating specialized prompts increasing the system's efficiency and reducing likelihood of human error in manual prompt formulation. Certain described aspects further provide the technical benefit of employing application programming interface (API) calls to send the generated prompts to the language model, reducing local resource consumption, such as CPU and memory usage on the system or a document editing application employing the system, leading to improved performance and responsiveness. Described aspects further provide the technical benefit of increased horizontal scalability, being employable by one or more document editing applications, and further being configured to assist large user bases simultaneously, ensuring that in the presence of increased demand, described systems can manage higher traffic without degrading performance, benefiting both the system and the document editing application employing the system. Furthermore, described aspects provide enhanced context-aware specialized prompt generation, improving workflow efficiency in providing comprehensive writing enhancement by reducing the need for prompt reworks on the part of the user. The aforementioned technical benefits provided by described embodiments are merely illustrative. Additional technical benefits may be better understood in view of the illustrative aspects described below.

### Example Systems and Methods for Providing Comprehensive Writing Enhancement

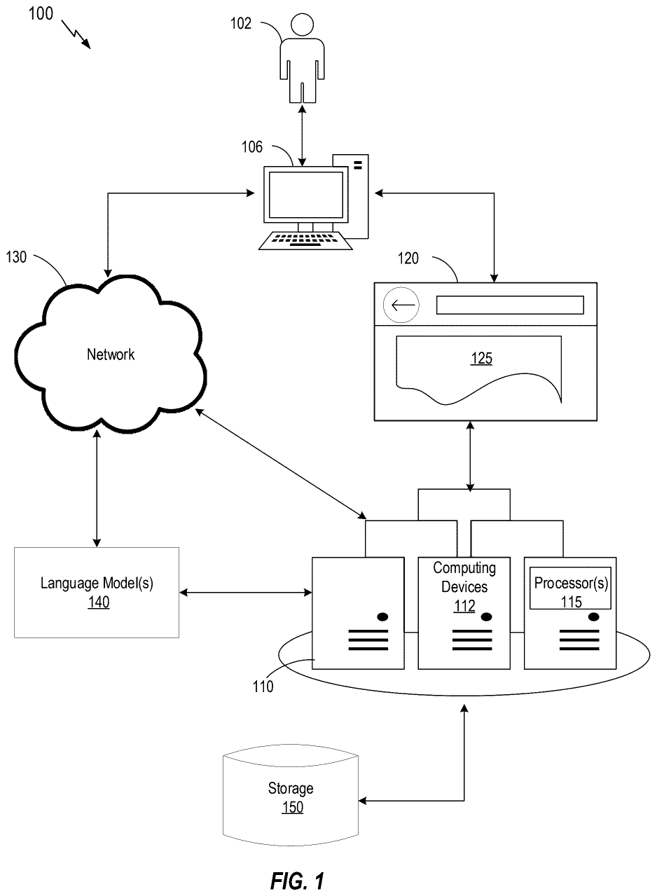

FIG. 1 depicts an illustrative environment 100 for implementing a writing enhancement system 110 according to one or more aspects shown and described herein. The writing enhancement system 110 may be configured to interface with a user 102 seeking to improve writing content, such as a resume. User 102 may interface with aspects of writing improvement system 110, for example implemented by one or more computing devices, through a device 106. In certain aspects, device 106 may be a personal computer, a tablet computer, a smart device (e.g., smartphone), or the like.

Device 106 may include a display device for implementing a user interface for the respective user, one or more processors for executing logic and one or more non-transitory computer-readable mediums for storing information and/or computer readable instructions. Device 106 operates as an interface for interacting with a document editing application 120 employing described aspects via a suitable user interface 125. Device 106 may access document editing application using network 130, which may be a wide area network (WAN), such as the Internet, a local area network (LAN), or any other type of network connection, including a connection that spans multiple networks.

A document editing application 120 is configured to communicate with and employ writing enhancement system 110 to provide comprehensive writing enhancement and transformed writing content to a user of document editing application 120.

Writing enhancement system 110 is configured to perform processes for providing comprehensive writing enhancement using one or more computing devices 112. The one or more computing devices 112 of writing enhancement system 110 include one or more processors 115 and one or more non-transitory computer-readable mediums storing computer readable instructions that, when executed by the one or more processors, cause the one or more computing devices to perform processes defined by computer-readable instructions corresponding to one or more components depicted and described herein. In some examples, a user of document editing application 120 may interface with aspects of writing enhancement system 110 via user interface 125 supported by the one or more computing devices 112 and processors 115 of writing enhancement system 110 to display icons and buttons for a user to interact with for submitting requests to enhance writing content.

In certain aspects, to perform processes described herein, writing enhancement system 110 is further configured to communicate with and leverage language model(s) 140, such as one or more artificial intelligence-based machine learning models including, but not limited to language models such as OpenAI's ChatGPT, NeMO™ LLM from NVIDIA®, LLaMa from Meta®, BERT from Google®, CLAUDE™ from Anthropic A.I., and FLAN-T5 form Google®. Components of the processes described herein can implement one or more language models currently developed or that may be developed in the future. In certain aspects, language model 140 is installed and hosted locally within writing enhancement system 110. In some aspects, language model 140 is utilized using API calls.

In certain aspects, to perform processes described herein, writing enhancement system 110 is further configured to store data, such as user feedback, into an accessible database 150.

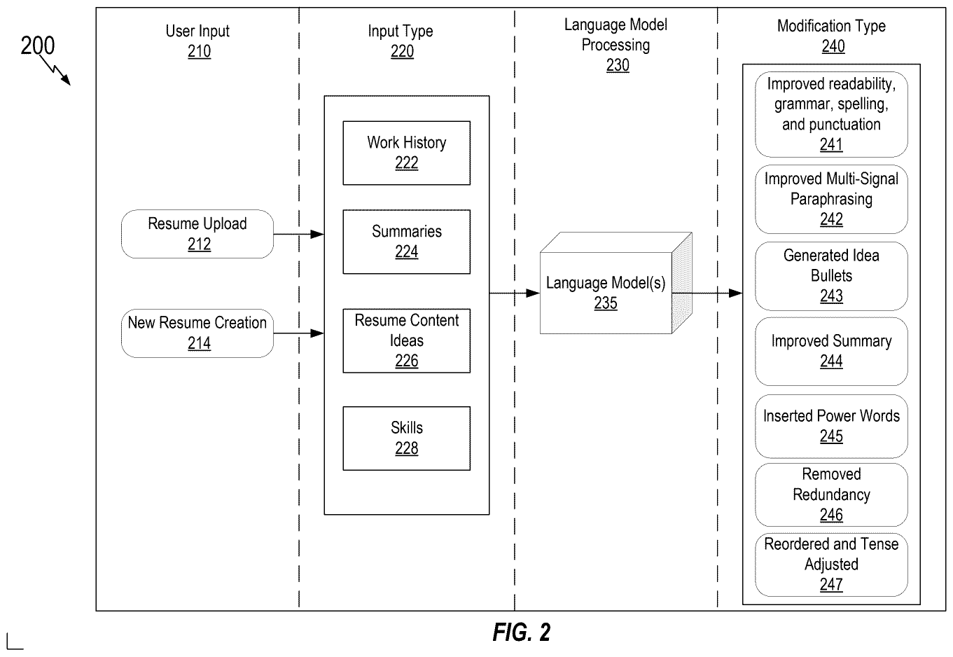

FIG. 2 depicts an illustrative process 200 implemented by a writing enhancement system 110 for providing comprehensive writing enhancement according to one or more aspects shown and described herein. In a first stage, user input 210 including writing content is received via a document editing application (such as document editing application 120 of FIG. 1) employing writing enhancement system 110. In certain aspects, a user may input writing content via a resume upload 212 or via new resume creation 214. In certain aspects, new resume creation 214 may include a user inputting writing content useful for building any portion of a resume. As an example, writing content for building any portion of a resume may include work experience, skills, summaries, education, or any other sections or information types useful for building a resume. In certain aspects the input writing content for building the resume may be in any format. As an example, the formatting of the input writing content may include words, phrases, sentences, paragraphs, sections, excerpts, bullets, lines, or any other suitable formats for writing content as may be useful for building any portion of a resume. In certain aspects, a user may input writing content by selecting, from a suitable user interface of a document editing application employing described aspects, predetermined writing content including work experience excerpts, bullets, or sentences. In some aspects, a user may instead manually write and input writing content into a window of a suitable user interface of a document editing application employing described aspects.

As shown, a user may request writing enhancement system 110 to transform user input writing content of various input types 220 including but not limited to work history 222, summaries 224, resume content ideas 226, skills 228, and other input types as may be useful for building a resume.

Writing enhancement system 110 may then utilize language model processing 230 to leverage language model(s) 235 to generate transformed writing content for the received input. As will be described in greater detail below, writing enhancement system 110 may be configured to generate specialized prompts, based on a received user request. Writing enhancement system 110 then calls language model(s) 235 to generate transformed writing content by processing the generated specialized prompt to apply a variety of different writing modification types 240 based on corresponding user requests. In certain aspects, the writing modification types may include grammar, spelling, and punctuation 241, improved multi-signal paraphrasing 242, generated idea excerpts 243, improved summaries 244, inserted power words 245, removed redundancy 246, and reordered and tense adjusted 247. In some aspects, other writing modification types are envisioned, as may be useful for providing comprehensive writing enhancement to a user of writing enhancement system 110. It may be appreciated that writing enhancement system 110 leverages a singular system architecture capable of generating specialized prompts based on a user request and an indication of a writing modification type to cause one or more language models to assist in generating transformed writing content to be returned to the user of a document editing application. This provides users with comprehensive writing enhancement including diverse functionalities for improving writing, overcoming the constraints of conventional writing assistance tools.

Language models are sometimes distinguished as between a “large” language model (LLM) and a “small” language model (SLM) based on the size and complexity of the model, which affects their capabilities and applications. LLMs are often characterized by their large number of parameters, ranging from hundreds of millions to trillions of parameters. This extensive scale enables them to capture complex language patterns and nuances. LLMs are trained on vast datasets that often include diverse and extensive sources of text from the internet, books, articles, and various other textual corpora (e.g., domain-specific corpora). The large volume of training data contributes to their broad generalization capabilities. Due to their size and comprehensive training, LLMs exhibit excellent language understanding and generation abilities. Relatedly, LLMs require significant computational resources for both training and inference. This includes, for example, powerful hardware such as multiple GPUs or TPUs and substantial memory and storage capacity.

SLMs have a smaller number of parameters, compared to LLMs, often ranging from tens of thousands to a few hundred million parameters. This relatively smaller size bounds their ability to capture complex language patterns. SLMs are often trained on smaller datasets compared to LLMs. The training data is typically more focused and less diverse, aimed at specific tasks or domains. While SLMs can still perform various language-related tasks, their performance is usually limited compared to LLMs. However, SLMs require significantly fewer computational resources for training and inference. They can be run on more modest hardware setups, making them suitable for applications with constrained resources or where quick deployment is essential.

Thus, LLMs offer enhanced performance and versatility at the cost of higher computational resource requirements, while SLMs provide a more resource-efficient solution with limitations in performance and capabilities. The choice between an LLM and an SLM depends on the specific application requirements and resource constraints.

Language model(s) 235 may be LLMs, SLMs, or a combination. In either case, such models may be fine-tuned to perform the modification types 240. In some instances, SLMs may be used for each modification type to reduce compute, memory, and power used by the system. Because the modification type may be targeted, an SLM may in certain instances allow for sufficient objective performance with improved compute efficiency compared to an LLM. On the other hand, an LLM may be fine-tuned to perform, in some instances, multiple of the modification types 240.

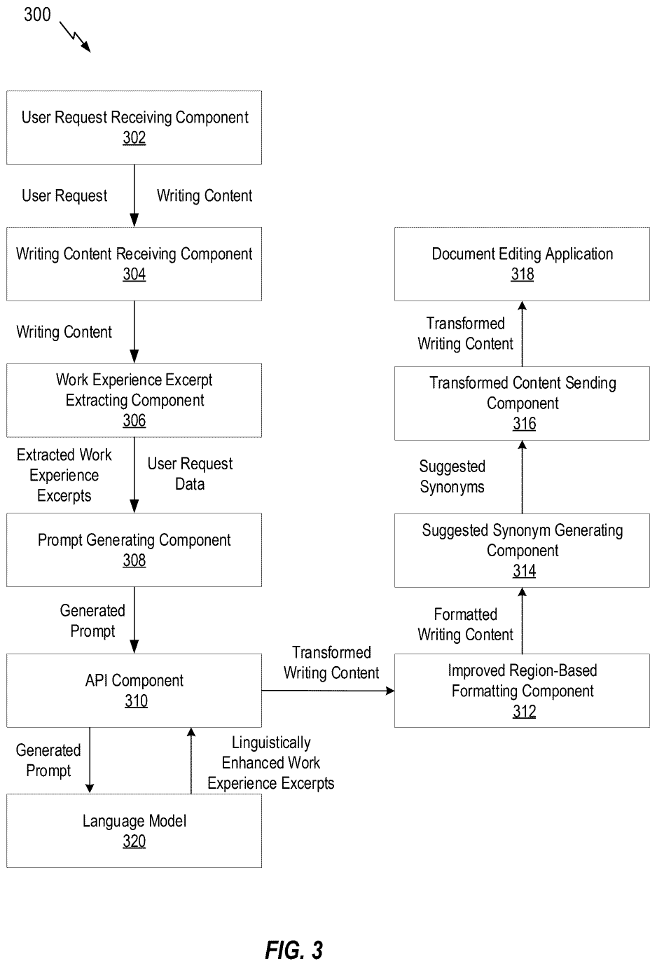

FIGS. 3-11 depict illustrative processes that may be implemented by writing enhancement system 110 to provide transformed writing content to a user of a document editing application. In certain aspects, writing enhancement system 110 generates the specialized prompts further based on one or more secondary inputs. As used herein, secondary inputs may include any additional text, features, context, or preferences provided by the user of the document editing application employing writing enhancement system 110. Various illustrative processes performable by a writing enhancement system 110 are described in greater detail below.

FIG. 3 depicts an illustrative process 300 implemented by a writing enhancement system 110 to provide transformed writing content including linguistically enhanced work experience excerpts according to one or more aspects shown and described herein.

First, a user request receiving component 302 of writing enhancement system 110 receives, from a user of a document editing application employing writing enhancement system 110, a user request to enhance or transform writing content. As previously discussed, the user request may include an indication of the writing modification to be applied to writing content associated with the user request, such as, an indication to linguistically enhance the work experience excerpts. As used herein, “linguistically enhanced” writing content may refer to writing content that has been modified to accommodate linguistic preferences (e.g. American vs. British English) and to address specific enhancement needs, such as grammar correction and vocabulary expansion. In certain aspects, the indication of the writing modification may be based on a functionality associated with the user request implemented within the user interface (such as user interface 125 of FIG. 1.) For example, the user interface may include a selectable icon or a drop-down menu configured to send a user request for applying a specific writing modification to the writing content by executing a particular API for generating specialized prompts for sending to the language model.

A writing content receiving component 304 of writing enhancement system 110 then receives the writing content associated with the user request. As an example, the writing content receiving component 304 may receive a user uploaded resume.

A work experience excerpt extracting component 306 then extracts, from the writing content (e.g. the uploaded resume), work experience excerpts to be transformed. In some aspects, the work experience excerpts may include pre-determined work experience excerpts selected by the user via suitable user interface and received by writing content receiving component 304.

Illustrative process 300 proceeds with a prompt generating component 308 generating a prompt based on the extracted work experience excerpts and the user request data including the indication of the writing modification. Prompt generating component 308 is configured to generate a specialized prompt to cause a language model to generate transformed writing content by applying the requested writing modification (linguistic enhancements as described above) to the writing content including the extracted work experience excerpts. In certain aspects, prompt generating component 308 is configured to utilize one or more prompt templates specifically tailored to a given writing modification to be applied. As an example, a given prompt template may include fixed components and placeholders for certain variables that may be filled with specific text to be transformed, secondary inputs to be considered by the language model, or specific features or conditions related to a given writing modification to be applied to received writing content. Writing enhancement system 110 is thus configured to generate the specialized prompt based on enhanced context including the writing modification to be applied, the writing content itself, and certain other secondary inputs (described further in additional aspects below) to ensure the generated prompt is efficient and effective in causing the large language model to assist in transforming the content appropriately.

The ability of writing enhancement system 110 to generate enhanced context-aware specialized prompts provides a technical benefit of improving workflow efficiency in providing comprehensive writing enhancement by reducing the need for prompt reworks on the part of the user, and increases efficiency and energy consumption by reducing the need for sending and processing multiple prompts in the event that the user is unable to obtain a desired result. This is a reflection of the difficulty experienced by an average in generating prompts for effectively transforming writing content to apply a given writing modification. Of course, it may further be appreciated that writing enhancement system 110 generally removes the need for the user to leverage a language model or other writing assistance tools, as it is configured to provide transformed writing content in response to a simple user request to enhance writing content of various input types.

Writing enhancement system 110 then leverages, in this example, an API component 310 to execute an API call to send the generated prompt to a language model 320 for processing. The language model 320 may be a model hosted by the writing enhancement system 110 or a third-party model accessed via the API. Language model 320 then processes the prompt and sends the transformed writing content back to writing enhancement system 110. As an example, an illustrative work experience excerpt to be transformed may include “Developed and implemented scalable web applications using Java and Spring Framework.” Language model 320 then executes the generated prompt to generate transformed writing content including three linguistically enhanced work experience excerpts, including “Designed and executed scalable web solutions with Java and Spring Framework,” “Implemented Java and Spring Framework to develop scalable web applications,” and “Utilized Java and Spring Framework to create dynamic and scalable web solutions.” The transformed content includes three varied, succinct sentences that improve clarity and impact while maintaining the tenses of the original received writing content. The transformed writing content may then be sent back to writing enhancement system 110 for displaying to and incorporation by the user.

Illustrative process 300 further includes applying additional writing modifications to the transformed writing content using an improved region-based formatting component 312 and a suggested synonym generating component 314. Region-based formatting component 312 is configured to reformat the transformed writing content for a specific region of the user. In certain aspects, the specific region of the user may refer to a city or a country from which the user is accessing the document editing application employing writing enhancement system 110. Suggested synonyms generating component 314 is configured to generate a predetermined number of synonyms for key words contained within the work experience excerpts. In certain aspects, improved region-based formatting component 312 and suggested synonym generating component 314 of writing enhancement system 110 may be configured to perform API calls to respective APIs for leveraging tools for reformatting and synonym generation. Writing enhancement system 110 thus provides a technical benefit by employing the API calls to send the generated prompts to the language model, thereby reducing local resource consumption, such as CPU and memory usage used by writing enhancement system 110 or the document editing application employing the writing enhancement system 110. This may further lead to improved performance and responsiveness within writing enhancement system 110 and the document editing application.

In certain aspects, the transformed writing content including the linguistically enhanced work excerpts, and any additional writing modifications, may be sent back to a document editing application 318 via a transformed content sending component 316.

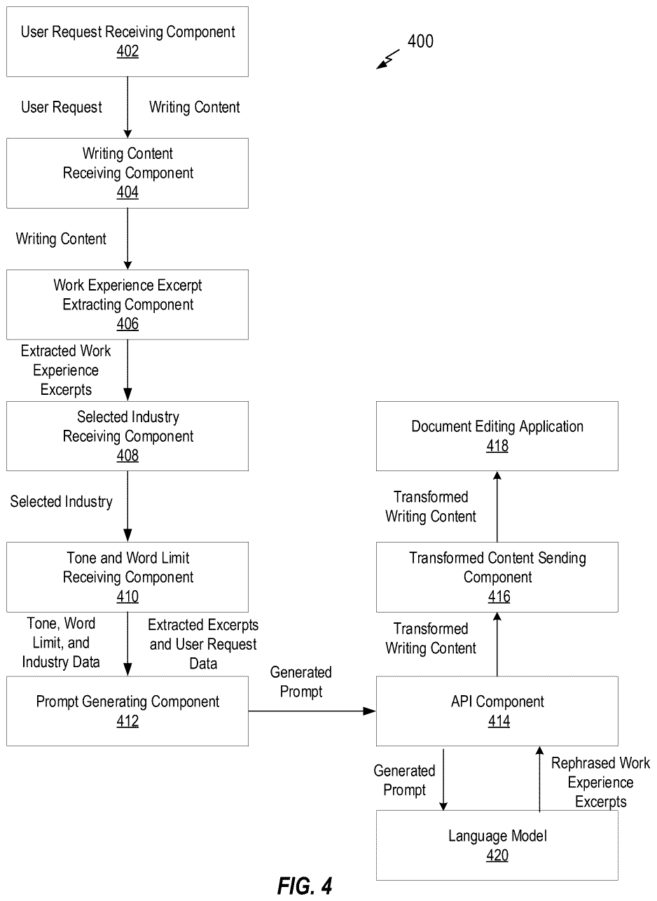

FIG. 4 depicts an illustrative process 400 implemented by a writing enhancement system 110 to provide transformed writing content including rephrased writing content according to one or more aspects shown and described herein. Certain steps of illustrative process 400 are substantially similar to those described above in connection with illustrative process 300. More specifically, certain common steps including receiving a user request via a user request receiving component 402, receiving writing content to be transformed via writing content receiving component 404, extracting work experience excerpts using a work experience excerpt extracting component 406, making API calls using an API component 414 to execute a generated prompt, and receiving transformed writing content at a transformed content sending component 416 for sending the transformed writing content to the document editing application are omitted in certain illustrative processes below for conciseness and clarity.

In illustrative process 400, writing enhancement system 110 is configured to leverage secondary inputs for generating the specialized prompt for causing the language model to generate rephrased writing content. As used herein, “secondary inputs” may refer to any inputs in addition to the received writing content for providing a language model context or additional information useful for applying a specific writing modification to received writing content. In certain aspects, secondary inputs include variables within a prompt template for generating a specialized prompt for causing the language model to apply a specific writing modification to generated transformed writing content. In some aspects, the secondary inputs are selected by the user via a suitable user interface of a document editing application employing writing enhancement systems described herein. In some examples, the secondary input may be input into a field of a suitable user interface of a document editing application by the user. The secondary inputs in illustrative process 400 include a user-selected industry, user-selected tone, and/or word limits received by a selected industry receiving component 408 and a tone and word limit receiving component 410 of writing enhancement system 110. The received secondary inputs and the writing content to be modified are then sent to prompt generating component 412. In turn, prompt generating component 412 of writing enhancement system 110 generates a prompt configured to cause language model 420 to generate rephrased writing content while further taking into consideration the secondary inputs including the user-selected industry, tone, and/or word limit. The rephrased writing content is then returned to a document editing application 418.

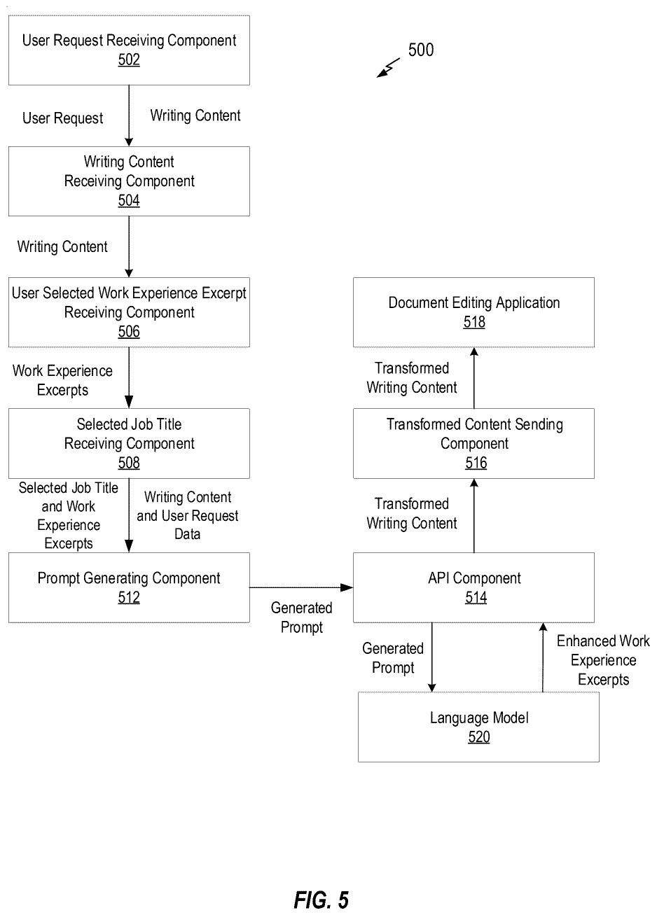

FIG. 5 depicts an illustrative process 500 implemented by a writing enhancement system 110 to provide transformed writing content including enhanced work experience excerpts according to one or more aspects shown and described herein. Certain steps of illustrative process 500 are substantially similar to those described above in connection with illustrative processes 300-400 of FIGS. 3 and 4. More specifically, certain common steps performed by a user request receiving component 502, a writing content receiving component 504, a user selected work experience excerpt receiving component 506, a prompt generating component 512, an API component 514, and a transformed content sending component 516 are omitted in certain illustrative processes below for conciseness and clarity.

In illustrative process 500, a selected job title receiving component 508 of writing enhancement system 110 receives a user-selected job title as a secondary input. In certain aspects, the user-selected job title corresponds to a job the user plans to apply to. Writing enhancement system 110 may then generate a prompt configured to cause language model 520 to generate transformed writing content including enhanced work experience bullets based on the writing content and the user-selected job title. As an example, a user may input writing content including text stating “Foreman, 20 years of experience, commercial property development, and skilled in equipment operation and maintenance, OSHA, resource allocation, mathematics and dishwashing,” and a user-selected job title of “Foreman.” The generated prompt may then cause the language model to output enhanced work experience bullets stating “Managed commercial property development projects for 20 years,” “Operated and maintained equipment in compliance with OSHA standards,” and “Allocated resources effectively to maximize efficiency productivity,” and “Utilized strong mathematics skills to analyze project requirements.” The enhanced writing content is then returned to a document editing application 518.

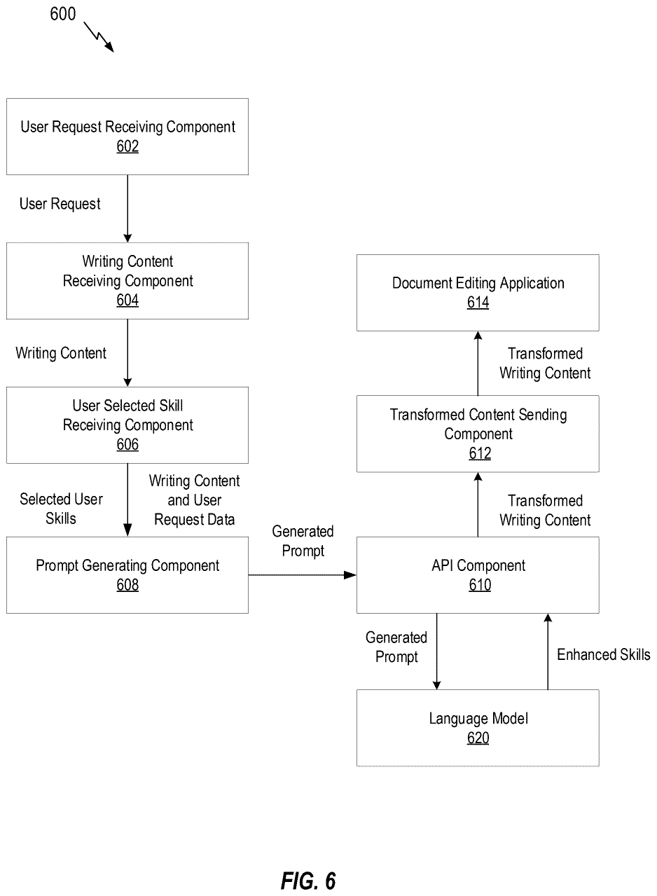

FIG. 6 depicts an illustrative process 600 implemented by a writing enhancement system 110 to provide transformed writing content including modified skills according to one or more aspects shown and described herein. Certain steps of illustrative process 600 are substantially similar to those described above in connection with at least illustrative processes 300-400 of FIGS. 3 and 4. More specifically, certain common steps performed by a user request receiving component 602, a writing content receiving component 604, a user selected skill receiving component 606, a prompt generating component 608, an API component 610, and a transformed content sending component 612 are omitted in certain illustrative processes below for conciseness and clarity.

In illustrative process 600, writing enhancement system 110 is configured to generate a prompt based on user-selected skills to cause the language model 620 to generate enhanced skills by refining and diversifying the presentation of the user-selected skills, ensuring they are articulated in a manner that is both precise and appealing. As an example, a user-selected skill of “Machine assembly and disassembly” may be used to generate transformed writing content including enhanced skills such as “Machine Assembly,” “Machine Disassembly,” and “Mechanical Assembly.” The enhanced writing content is then returned to a document editing application 614.

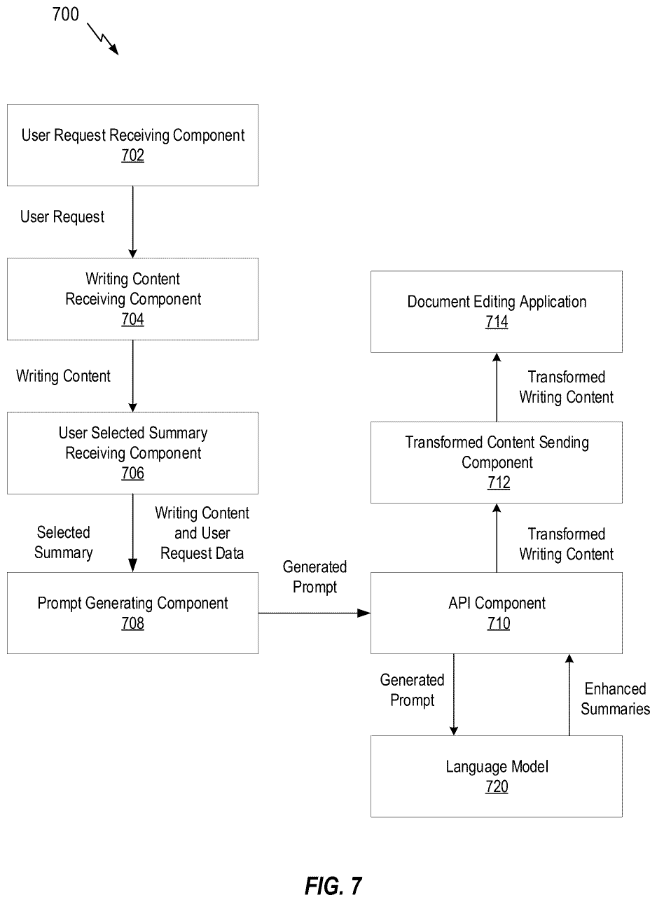

FIG. 7 depicts an illustrative process 700 implemented by a writing enhancement system 110 to provide transformed writing content including modified summaries according to one or more aspects shown and described herein. Certain steps of illustrative process 700 are substantially similar to those described above in connection with at least illustrative processes 300-400 of FIGS. 3 and 4. More specifically, certain common steps performed by a user request receiving component 702, a writing content receiving component 704, a user selected summary receiving component 706, a prompt generating component 708, an API component 710, and a transformed content sending component 712 are omitted in certain illustrative processes below for conciseness and clarity.

In illustrative process 700, writing enhancement system 110 is configured to generate a prompt based on user-selected summaries (e.g. summary sections within a resume) to cause the language model 720 to generate enhanced summaries. As an example, writing enhancement system 110 may generate a prompt configured to cause language model 720 to process text of the user-selected summary to improve its overall readability and coherence, focusing on making the summary more compelling and professional for use in a resume. As an example, a portion of a summary section input by the user may state “Current student and dependable employee seeking part-time employment to help grow skills and contribute to a successful environment.” The generated prompt may then cause the language model to generate an enhanced summary stating, “Motivated and reliable current student with a strong desire to enhance skills and make a valuable contribution in a part-time role. Committed to personal growth and eager to thrive in a successful work environment. Seeking an opportunity to apply dedication, adaptability, and strong work ethic to support the goals of an organization.” The enhanced writing content is then returned to a document editing application 714.

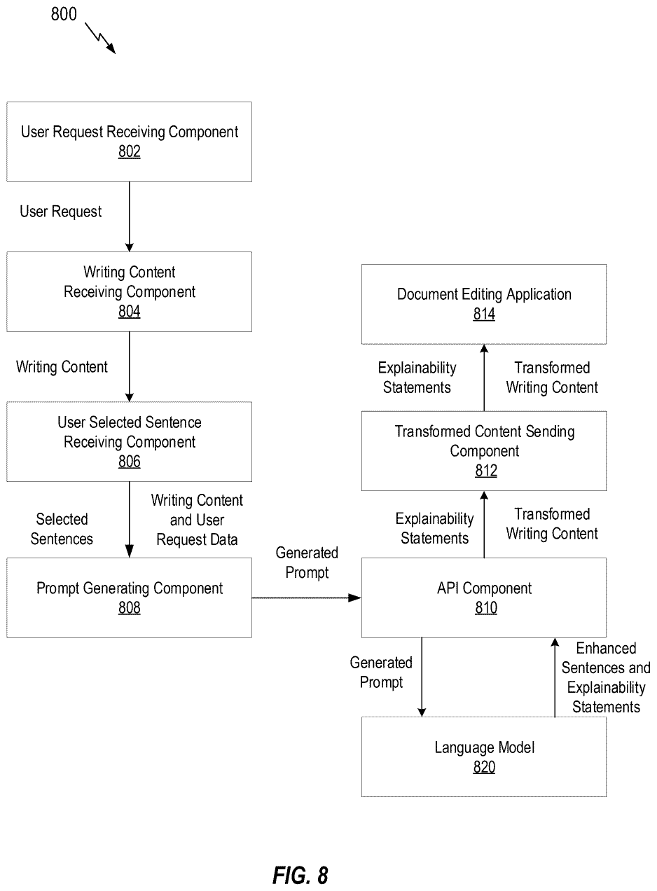

FIG. 8 depicts an illustrative process 800 implemented by a writing enhancement system 110 to provide transformed writing content including modified sentences having inserted power words according to one or more aspects shown and described herein. Certain steps of illustrative process 800 are substantially similar to those described above in connection with at least illustrative processes 300-400 of FIGS. 3-4. More specifically, certain common steps performed by a user request receiving component 802, a writing content receiving component 804, a user selected sentence receiving component 806, a prompt generating component 808, an API component 810, and a transformed content sending component 812 are omitted in certain illustrative processes below for conciseness and clarity.

In illustrative process 800, writing enhancement system 110 is configured to generate a prompt based on user-selected sentences (e.g. sentences of a resume) to cause the language model 620 to generate enhanced sentences by inserting power words to improve the user-selected sentences by making them dynamic and impactful. As used herein, “power words” may refer to individual words or phrases which qualify or enhance impact of a given line of text. As an example, writing enhancement system 110 may receive a use selected sentence stating “Developed and implemented scalable web applications using Java and Spring Framework.” Writing enhancement system 110 may then send a generated prompt to language model 820, causing language model 820 to generate an enhanced sentence stating “Developed and implemented highly scalable web applications utilizing Java and the Spring Framework,” including the power words “highly” and “utilizing”. The enhanced writing content is then returned to a document editing application 814.

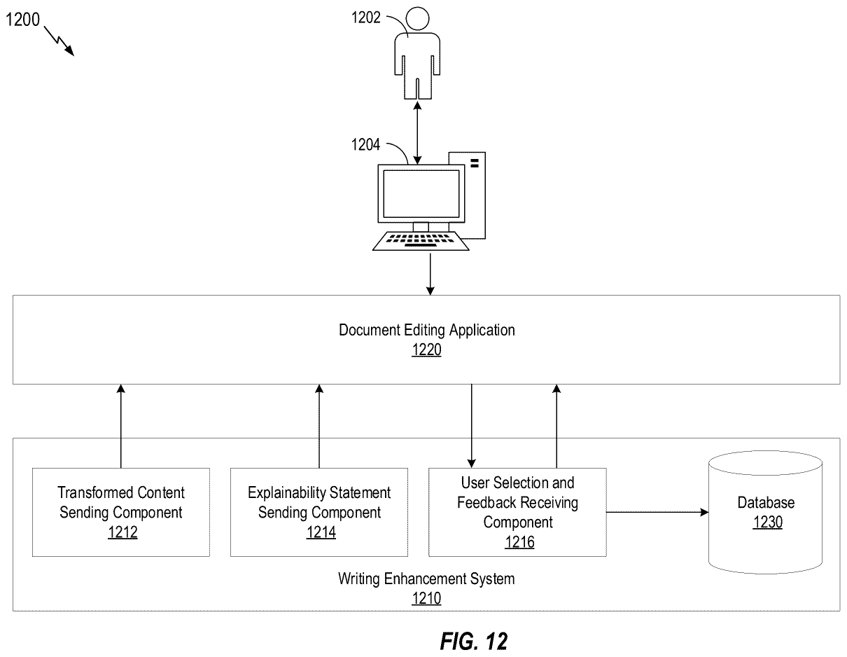

In certain aspects, the prompt generated by writing enhancement system 110 may further be configured to cause language model 820 to generate explainability statements including reasoning and rationales for why certain power words were inserted into the user-selected sentence. As an example, the generated prompt may cause language model 820 to generate explainability statements for the above example stating: “By replacing ‘scalable’ with ‘highly scalable,’ the statement emphasizes the ability to handle large amounts of data and traffic, showcasing expertise and capability. Additionally, the use of ‘utilizing’ instead of ‘using’ conveys a more proactive and dynamic approach to development.” In certain aspects, writing enhancement system 110 sends the explainability statements to the user, as will be described in greater detail in connection with FIG. 12 below. In some aspects, explainability statements may be provided to the user with any transformed writing content generated by applying a suitable modification for improving received writing content in accordance with techniques described herein.

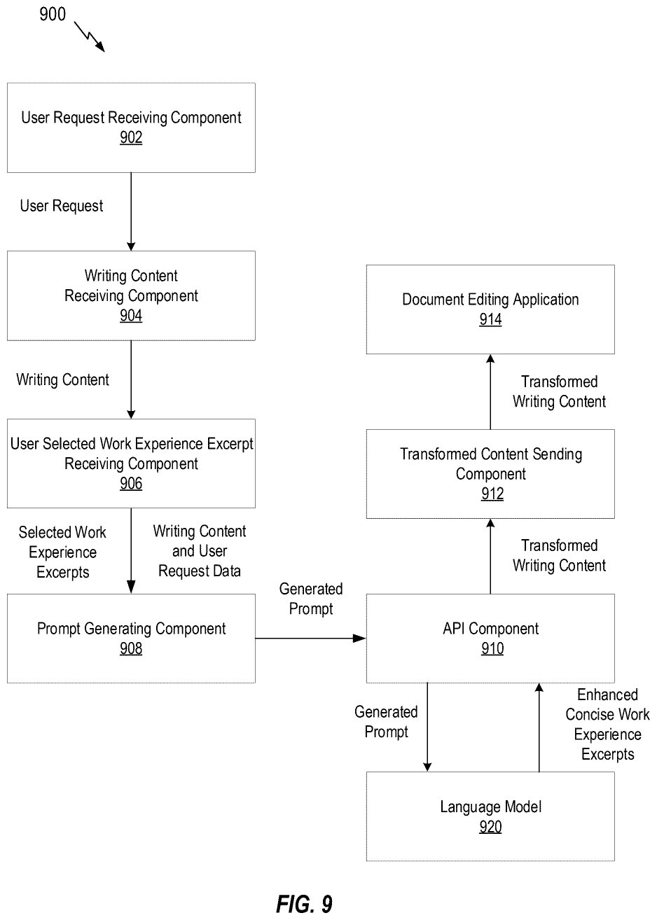

FIG. 9 depicts an illustrative process 900 implemented by a writing enhancement system 110 to provide transformed writing content having fewer redundancies according to one or more aspects shown and described herein. Certain steps of illustrative process 900 are substantially similar to those described above in connection with at least illustrative processes 300-400 of FIGS. 3 and 4. More specifically, certain common steps performed by a user request receiving component 902, a writing content receiving component 904, a user selected work experience excerpt receiving component 906, a prompt generating component 908, an API component 910, and a transformed content sending component 912 are omitted in certain illustrative processes below for conciseness and clarity.

In illustrative process 900, writing enhancement system 110 is configured to generate a prompt based on user-selected sentences (e.g. sentences of a resume) to cause the language model 920 to generate enhanced sentences by removing unnecessary repetition in the writing content. In certain aspects, the user-selected sentences are manually selected from an uploaded resume. In some aspects, the user-selected sentences are chosen by the user based on an extracted list of one or more sentences provided by the document editing application. As an example, a user may select a sentence stating “Supervised, watched over, and cared for children ages 3 months to 8.” A generated prompt may then cause the language model to generate enhanced sentences stating “Supervised children ages 3 to 8 months.” The redundancies including the text “watched over” and “cared for” were removed, enhancing the quality and readability of the input sentence. The enhanced writing content is then returned to a document editing application 914.

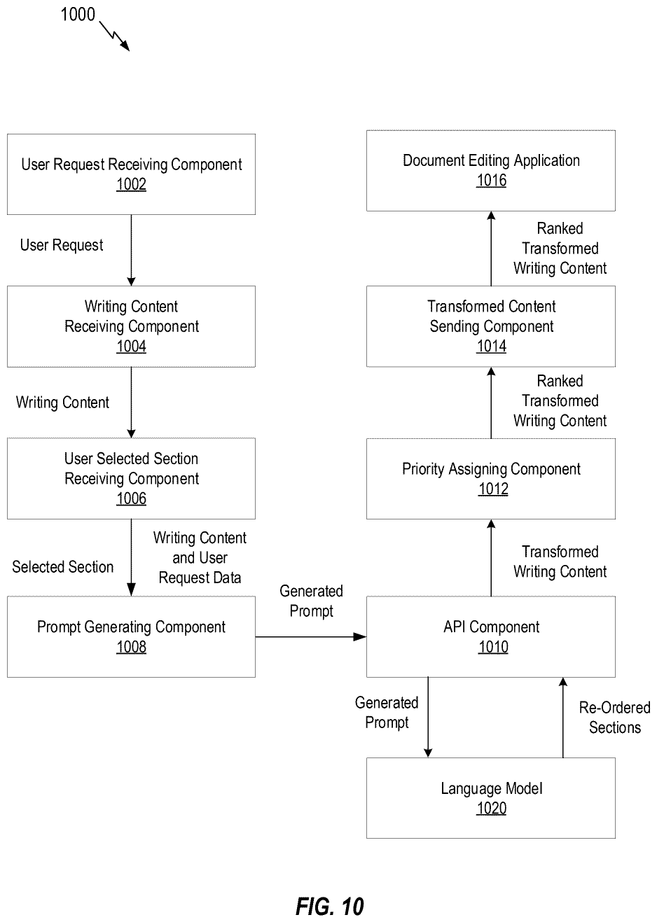

FIG. 10 depicts an illustrative process 1000 implemented by a writing enhancement system 110 to provide transformed writing content having reordered sections according to one or more aspects shown and described herein. Certain steps of illustrative process 1000 are substantially similar to those described above in connection with at least illustrative processes 300-400 of FIGS. 3 and 4. More specifically, certain common steps performed by a user request receiving component 1002, a writing content receiving component 1004, a user selected section receiving component 1006, a prompt generating component 1008, an API component 1010, and a transformed content sending component 1014 are omitted in certain illustrative processes below for conciseness and clarity.

In illustrative process 1000, writing enhancement system 110 is configured to generate a specialized prompt based on user-selected sections (e.g. sections of text in a resume) to cause the language model 1020 to generate enhanced sections by reordering text to prioritize the user's most relevant skills and achievements. This helps the writing to capture the attention of potential employers and enhance the overall readability and impact of the resume. In certain aspects the user may manually select sections of an uploaded resume. In some aspects, the user may be provided with a list of extracted sections of text, via the user interface of the document editing application, to be improved, and then manually select one or more sections to improve. Illustrative process 1000 further includes writing enhancement system 110 utilizing a priority assigning component 1012 configured to employ any suitable known algorithms for assigning priority rankings to the re-ordered sections. For example the employed algorithm may use rule-based rankings or a weight classification-based algorithm. As an example, priority assigning component 1012 may employ an algorithm that assigns a first highest priority to sections with quantifiable outcomes (e.g., metrics, numbers, percentages), a second lower priority to sections including achievements (e.g., awards, recognitions), and a third lowest priority to sections including general tasks and skill-heavy descriptions. The enhanced writing content is then returned to a document editing application 1016.

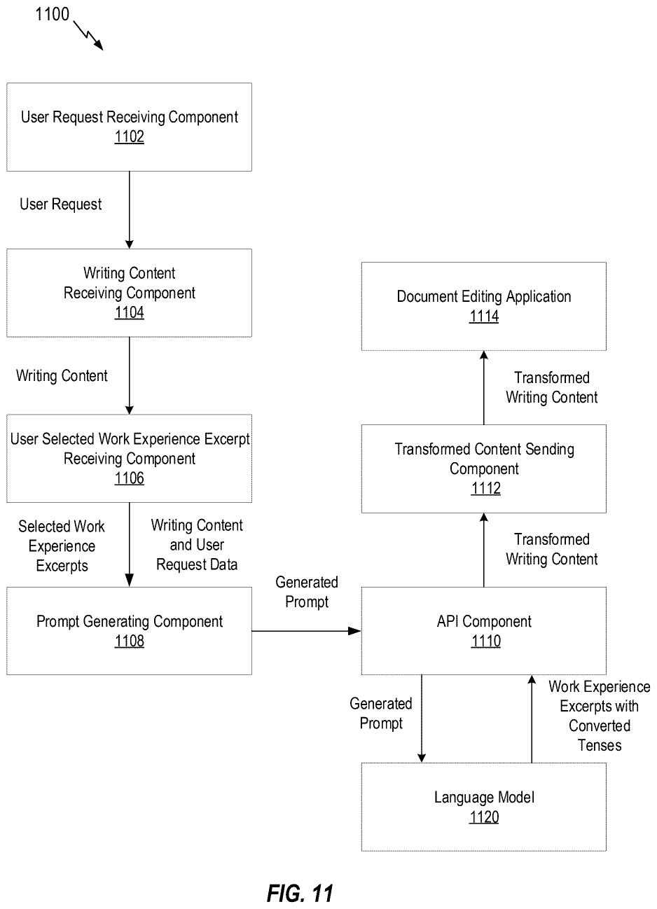

FIG. 11 depicts an illustrative process 1100 implemented by a writing enhancement system 110 to provide transformed writing content having converted tenses according to one or more aspects shown and described herein. Certain steps of illustrative process 1100 are substantially similar to those described above in connection with at least illustrative processes 300-400 of FIGS. 3 and 4. More specifically, certain common steps performed by a user request receiving component 1102, a writing content receiving component 1104, a user selected work experience excerpt receiving component 1106, a prompt generating component 1108, an API component 1110, and a transformed content sending component 1112 are omitted in certain illustrative processes below for conciseness and clarity.

In illustrative process 1100, writing enhancement system 110 is configured to generate a prompt based on user-selected work experience excerpts to cause the language model 1120 to generate alternate work experience excerpts including a first alternative excerpt adjusted to past tense (suitable for describing completed roles and responsibilities) and second alternative excerpt adjusted to present continuous tense (ideal for ongoing tasks and roles) for each of the user-selected excerpts. As an example, the user may input writing content stating “Build high-performing teams through effective recruit processes, trained programs, coaching sessions.” The generated prompt may then cause the language model to generate a first transformed excerpt in past tense stating “Built high-performing teams through effective recruitment processes, training programs, and coaching sessions,” and a second transformed excerpt in present tense stating “Building high-performing teams through effective recruitment processes, training programs, and coaching sessions.” This flexibility allows users to tailor their resume content according to the context of their experiences, whether they are describing past roles or ongoing responsibilities. The enhanced writing content is then returned to a document editing application 1114.

It may be understood that the writing modifications and transformed content generated by performing the illustrative processes described above in connection with FIGS. 3-11 are merely exemplary. In certain other aspects, writing enhancement system 110 may be configured to generate alternative specialized prompts to call a language model to assist in generating transformed writing content to provide comprehensive writing enhancement to a user of a document editing application that is employing writing enhancement system 110.

FIG. 12 depicts an illustrative process 1200 implemented by a writing enhancement system 1210 to send transformed writing content and explainability statements to a user, and to receive corresponding user feedback according to one or more aspects shown and described herein. In illustrative process 1200, a user 1202 is interacting with a document editing application 1220 employing writing enhancement system 1210. User 1202 uses a device 1204 to interact with a suitable user interface of document editing application 1220. A transformed content sending component 1212 of writing enhancement system 1210 sends transformed writing content to document editing application 1220 to display to user 1202 via a suitable user interface. Writing enhancement system 1210 may further leverage an explainability statement sending component 1214 to send, to the user 1202, statements providing reasoning or rationales for how and/or why writing modifications were applied to generate the transformed content. A user selection and feedback component 1216 of writing enhancement system 1210 is configured to receive, from document editing application 1220, user selection data and user feedback related to the user's responses to the sent transformed writing content. As an example, document editing application 1220 may present user 1202 with received transformed writing content with an option for the user to select which portion of the transformed content to accept or reject. The user's selection may then be sent, by document editing application 1220, to the user selection and feedback component 1216 of writing enhancement system 1210. In some aspects, user selection and feedback component 1216 of writing enhancement system 1210 may be configured to store any received user selection data or feedback from user 1202 into a database 1230, or any other suitable storage component. In certain aspects, the user selection data and feedback may be utilized to further train and tune employed language models that are locally maintained as a part of writing enhancement systems according to one or more aspects described herein. In certain aspects, the database 1230 may be a standalone storage component accessible by a company managing the document editing application 1220 employing writing enhancement system 1210. In such aspects, the feedback provides the organization with valuable insights into user preferences and common issues faced by job seekers in resume writing.

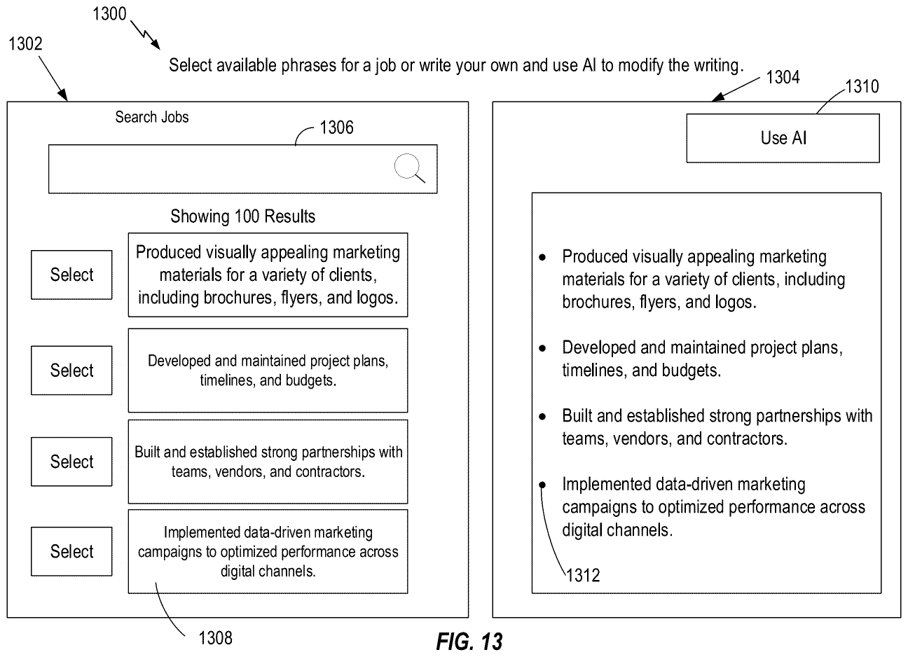

FIG. 13 depicts an illustrative user interface 1300 of a document editing application employing a writing enhancement system in accordance with aspects described herein to perform an illustrative processes of providing comprehensive writing enhancement.

In a first window 1302, a user may search for and enter a relevant job title in field 1306 to be used as a secondary input by the writing enhancement system when generating a prompt. The user may then select one or more work experience excerpts 1308 to be transformed and/or enhanced by the writing enhancement system.

In a second window 1304, the user-selected work experience excerpts 1312 are displayed to indicate the writing content to be modified. In some aspects, rather than selecting work experience excerpts from first window 1302, a user may instead manually input writing content into second window 1304. For example, the user may manually write and input words, sentences, bullets, or paragraphs (for inclusion within an uploaded document or a new document being built) into second window 1304.

Thereafter, to send a user request to transform the writing content, the user may select an icon 1310 configured to send the user request to transform the writing content to the user request receiving component (such as user request receiving component 302 of FIG. 3) of the writing enhancement system.

As previously described, the sent user request further includes an indication of the modification to be applied when transforming the user-selected writing content. In certain aspects, the indication may be based off of an input type of the user-selected writing content, a specific page or icon of the document editing application associated with a given writing modification, or a combination of both. As an example, a page or icon of the document editing application may be associated with enhancing writing content by removing redundancies, causing any user request from that page or using that icon to further include an indication that the applied writing modification includes removing redundancies in the user-selected writing content.

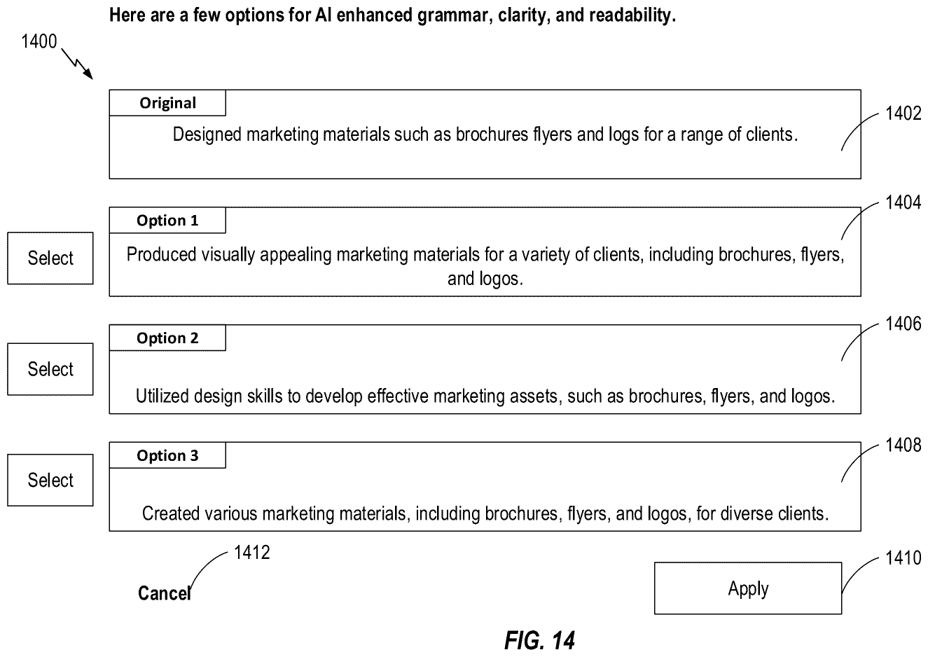

FIG. 14 depicts another illustrative user interface 1400 of a document editing application employing a writing enhancement system in accordance with described embodiments to perform an illustrative processes of providing comprehensive writing enhancement according to one or more aspects shown and described herein.

More specifically, user interface 1400 depicts transformed writing content provided by the writing enhancement system that is being displayed to the user of the document editing application. The original writing content 1402 selected by the user to be transformed by the writing enhancement system is shown towards a top portion of user interface 1400. The transformed writing content received from the writing enhancement system is then displayed to the user, via user interface 1400, as individual user selectable options 1404, 1406, and 1408. In some aspects, the number of options displayed to the user may be adjusted to include fewer or additional user selectable options including the transformed writing content. The user may reject the transformed writing content or return to a previous window of the document editing application by selecting an icon 1412 for canceling the request to transform the user-selected writing content. The user may accept or apply the transformed writing content by selecting an icon 1410.

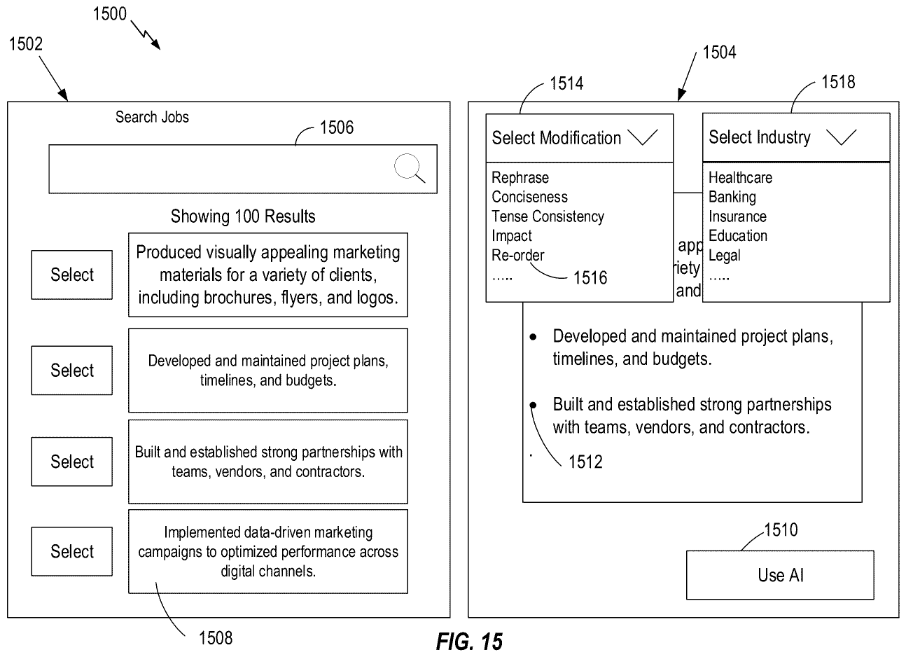

FIG. 15 depicts an illustrative user interface 1500 of a document editing application employing a writing enhancement configured to perform an illustrative processes of providing comprehensive writing enhancement according to one or more aspects shown and described herein.

User interface 1500 includes a first window 1502 in which a user searches for and enters a relevant job title in field 1506. The user then selects, at 1508, work experience excerpts to be transformed and/or enhanced by the writing enhancement system. The selected work experience excerpts are based on the selected job title from field 1506.

In a second window 1504, a user selects an icon 1510 configured to send the user request to transform the writing content to the user request receiving component (such as user request receiving component 302 of FIG. 3) of the writing enhancement system. Second window 1504 further displays selected work experience excerpts 1512 to indicate the writing content to be modified.

A first drop-down menu 1514 enables a user to select a specific modification from a set of selectable modifications 1516. Selecting a given modification 1516 causes an indication of the modification to be included when sending a corresponding user request to transform the writing content. For example, if the user selects a selectable modification entitled “rephrase” and then further selects icon 1510, a user request, including an indication of a writing modification for rephrasing the writing content, is sent to a writing enhancement system according to described embodiments. The writing enhancement system would then generate a prompt, based on the indication of the user-selected modification, for causing a language model to generated rephrased work experience excerpts (such as by performing illustrative process 400 as described above with reference to FIG. 4) based on the work experience excerpts 1512.

A second drop-down menu 1518 enables a user to select a relevant industry. As discussed, described embodiments may further utilize secondary inputs for providing additional context or information within a generated prompt for causing a language model to improve and transform received writing content. In certain aspects, the selected relevant industry may be incorporated within to a user request as a secondary input for generating prompts. For example, the user may select a relevant industry entitled “Banking”. The user may then select icon 1510, causing described aspects to receive the selected relevant industry of “Banking” with the user request. Described aspects may then generate a prompt for transforming the writing content that further leverages the selected relevant industry as a secondary input for providing additional context to the language model.

In certain aspects, drop-down menu 1518 enables users to manually enter a secondary input. For example, the user may enter “Finance”, thereby causing “Finance” to be received by described aspects for use as a secondary input when generating prompts for transforming the writing content. In some examples, drop-down menu 1518 enables users to select or input different types of secondary inputs including but not limited a desired tone, a word limit, or other useful information for providing a language model context for generating improved writing. In some aspects, a suitable user interface may include multiple different fields or drop-down menus for enabling a user to select or provide additional indications of writing modifications or secondary inputs.

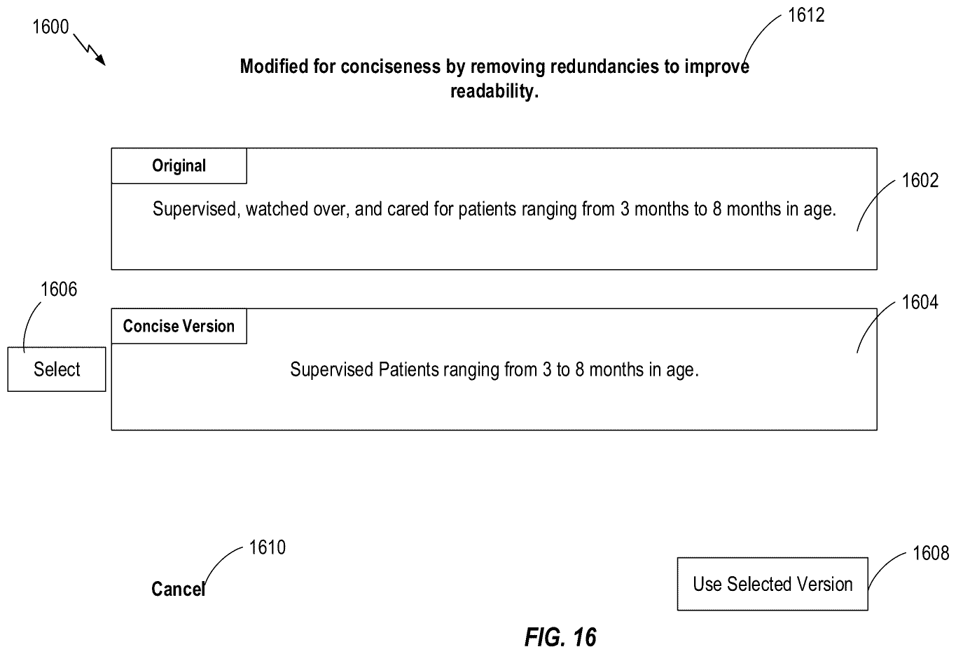

FIG. 16 depicts an illustrative user interface 1600 of a document editing application employing a writing enhancement system configured to perform an illustrative processes of providing comprehensive writing enhancement according to one or more aspects shown and described herein.

User interface 1600 includes a first window 1602 displaying original writing content that includes an example work experience excerpt. A second window 1604 includes a concise version generated by utilizing described aspects to transform (for example, using illustrative process 900 described above with reference to FIG. 9) the displayed original writing content. User interface 1600 further includes an icon 1606 that enables a user to select the generated concise version of the example work experience excerpt from second window 1604. The user may then select a second icon 1608 to use the selected version, thereby incorporating the writing modifications performed by described aspects to transform and improve the originally received writing content. Alternatively, the user may select an icon 1610 to return to a previous window without modifying the original writing content.

User interface 1600 further displays an explainability statement 1612. As discussed, explainability statements include reasoning and rationales for how and why the language model employed by described aspects applies certain modifications to the original writing content. Described aspects may send, to a user interface, explainability statements (for example using explainability statement sending component 1214 described above with reference to FIG. 12) generated by employed language models when generating transformed writing content. For example, the displayed explainability statement at 1612 explains to the user that the original writing was “Modified for conciseness by removing redundancies to improve readability.” Accordingly, the user is provided with an explanation detailing that the concise version has redundancies removed, and that the reasoning for removing the redundancies is to improve readability by making the original writing more concise. The explainability statement may assist the user in making a more informed decision when determining whether to keep original writing content, or replace the original content with the modified version generated by described aspects.

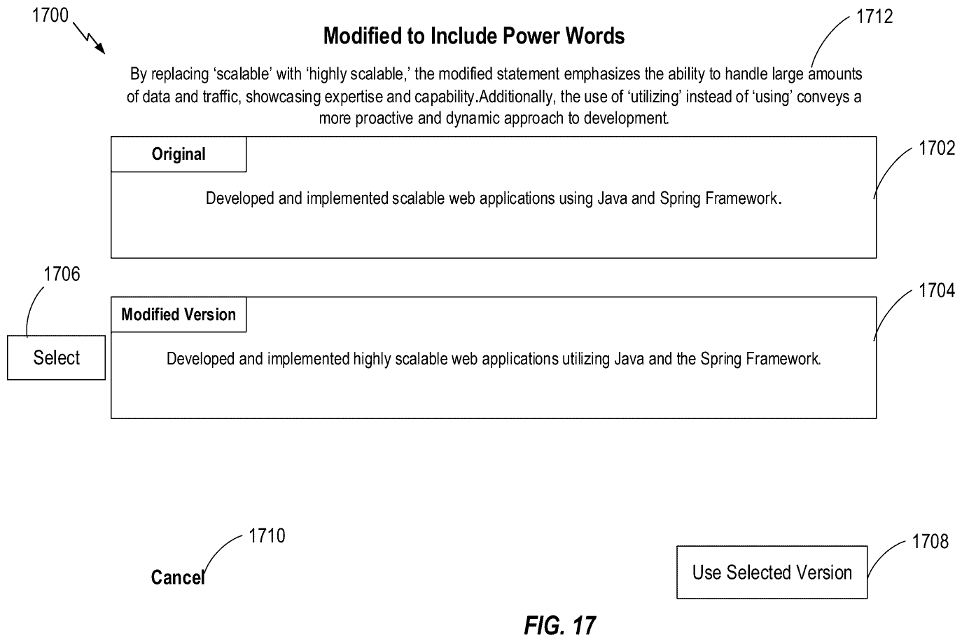

FIG. 17 depicts an illustrative user interface 1700 of a document editing application employing a writing enhancement system configured to perform an illustrative processes of providing comprehensive writing enhancement according to one or more aspects shown and described herein.

User interface 1700 includes a first window 1702 displaying original writing content including an example work experience excerpt. User interface 1700 further includes a second window 1704 displaying a modified version of the original writing content that has been generated by inserting power words (for example, using illustrative process 800 as described above with reference to FIG. 8) to enhance the example work experience excerpt. A user may select an icon 1706 to select the modified version in second window 1704. In certain aspects, user interface 1700 may display additional modified versions within separate additional windows to provide the user with more selectable options. The user may then select an icon 1708 to use the selected version, thereby incorporating the writing modifications performed by described aspects to transform and improve the originally received writing content. Alternatively, the user may select an icon 1710 to return to a previous window without modifying the original writing content.

User interface 1700 further displays an explainability statement 1712 for providing reasoning and rationales for the modifications made to the original writing content to generate the modified version in second window 1704. For example, for a modified version generated by inserting power words, described aspects may generate an explainability statement for sending to a user interface of a document editing application (for example using explainability statement sending component 1214 described above with reference to FIG. 12) to display to the user. The explainability statement may assist the user in understanding the modifications made to the writing to help the user in deciding whether to keep using the original writing content, or instead use the modified version of the writing content generated by described aspects.

### Example Method for Providing Comprehensive Writing Enhancement

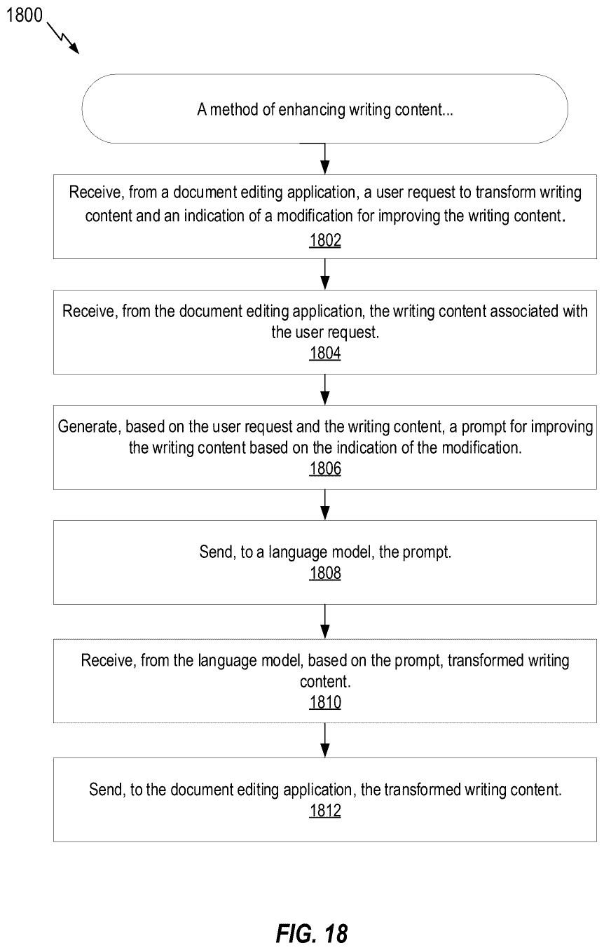

FIG. 18 depicts an example flow diagram of a method 1800 for providing a user with comprehensive writing enhancement according to one or more aspects shown and described herein.

In this example, method 1800 begins at block 1802 with receiving, from a document editing application, a user request to transform writing content and an indication of a modification for improving the writing content. For example, the receiving may be performed by one or more computing devices of a writing enhancement system, such as computing devices 112 of writing enhancement system 110, described above with reference to FIG. 1, configured to implement components such as the user request receiving component 302 of FIG. 3, and similar user request receiving components discussed above in connection with FIGS. 4-11.

Method 1800 then proceeds to block 1804 with receiving, from the document editing application, the writing content associated with the user request. For example, the receiving may be performed by one or more computing devices of a writing enhancement system, such as computing devices 112 of writing enhancement system 110, described above with reference to FIG. 1, configured to implement components such as the writing content receiving component 304 of FIG. 3, and similar writing content receiving components discussed above in connection with FIGS. 4-11.

Method 1800 then proceeds to block 1806 with generating, based on the user request and the writing content, a prompt for improving the writing content based on the indication of the modification. For example, the generating may be performed by one or more computing devices of a writing enhancement system, such as computing devices 112 of writing enhancement system 110, described above with reference to FIG. 1, configured to implement components such as the prompt generating component 308 of FIG. 3, and similar prompt generating components discussed above in connection with FIGS. 4-11.

Method 1800 then proceeds to block 1808 with sending, to a language model, the prompt. For example, the sending may be performed by one or more computing devices of a writing enhancement system, such as computing devices 112 of writing enhancement system 110, described above with reference to FIG. 1, configured to implement the API component 310 of FIG. 3, and similar API components discussed above in connection with FIGS. 4-11.

Method 1800 then proceeds to block 1810 with receiving, from the language model, based on the prompt, transformed writing content. For example, the receiving may be performed by one or more computing devices of a writing enhancement system, such as computing devices 112 of writing enhancement system 110, described above with reference to FIG. 1, configured to implement API component 310 of FIG. 3, and similar API components discussed above in connection with FIGS. 4-11.

Method 1800 then proceeds to block 1812 with sending, to the document editing application, the transformed writing content. For example, the sending may be performed by one or more computing devices of a writing enhancement system, such as computing devices 112 of writing enhancement system 110, described above with reference to FIG. 1, configured to implement the transformed content sending component 316 of FIG. 3, and similar transformed content sending components discussed above in connection with FIGS. 4-11.

In some aspects, method 1800 further includes receiving, a second user selection corresponding to accepted transformed writing content; receiving user feedback based on the accepted transformed writing content; and storing the user feedback and the second user selection in a storage component.

In some aspects, method 1800 further includes extracting one or more work experience excerpts from the writing content; and generating the prompt further based on the one or more work experience excerpts.

In some aspects, method 1800 further includes performing region-based reformatting of the transformed writing content; generating suggested synonyms for words in the transformed writing content; and sending the suggested synonyms for the words in the transformed writing content to a user.

In some aspects, method 1800 further includes receiving, from a user, one or more secondary inputs; and generating the prompt further based on the one or more secondary inputs. In certain aspects, the one or more secondary inputs comprise a user selected relevant industry, a user selected desired tone, and a user selected word limit, and the modification for improving the writing content comprises rephrasing the writing content based on the secondary inputs. In certain aspects, the one or more secondary inputs comprise a user selected job title and one or more user selected work experience excerpts, and the modification for improving the writing content comprises generating a set of enhanced work experience excerpts corresponding to the one or more user selected work experience excerpts and based on the writing content and the secondary inputs. In certain aspects, the one or more secondary inputs comprise user selected skills; and the modification for improving the writing content comprises generating alternative skills based on the writing content and the secondary inputs. In certain aspects, the one or more secondary inputs comprise one or more user selected summaries, and the modification for improving the writing content comprises generating alternative summaries based on the writing content and the secondary inputs. In certain aspects, the one or more secondary inputs comprise user selected work experience excerpts, and the modification for improving the writing content comprises inserting one or more power words into the writing content based on the writing content and the secondary inputs. In certain aspects, the one or more secondary inputs comprise one or more user selected work experience excerpts, and the modification for improving the writing content comprises removing one or more redundancies in the writing content based on the writing content and the secondary inputs. In certain aspects, the one or more secondary inputs comprise a work history section, and the modification for improving the writing content comprises re-ordering one or more excerpts within the writing content according to a set of prioritization rules in the generated prompt, and based on the writing content and the secondary inputs. In certain aspects, the one or more secondary inputs comprise one or more user selected work experience excerpts, and the modification for improving the writing content comprises modifying tenses of the writing content based on the writing content and the secondary inputs.

Systems and methods according to aspects described herein overcome the constraints of current writing assistance tools having limited writing assistance functionality by utilizing improved architecture that provides the technical benefit of enabling a singular system to provide a wide variety of writing enhancement functionalities by utilizing one or more language models. Systems and methods described herein for improved techniques of providing comprehensive writing enhancement further provide for various technical benefits. Aspects described herein include architecture for dynamically generating specialized prompts increasing the system's efficiency and reducing likelihood of human error in manual prompt formulation. Certain described aspects further provide the technical benefit of employing application programming interface (API) calls to send the generated prompts to the language model, reducing local resource consumption, such as CPU and memory usage on the system or a document editing application employing the system, leading to improved performance and responsiveness. Described aspects further provide the technical benefit of increased horizontal scalability, being employable by one or more document editing applications, and further being configured to assist large user bases simultaneously, ensuring that in the presence of increased demand, described systems can manage higher traffic without degrading performance, benefiting both the system and the document editing application employing the system. Furthermore, described aspects provide enhanced context-aware specialized prompt generation, improving workflow efficiency in providing comprehensive writing enhancement by reducing the need for prompt reworks on the part of the user.

Note that FIG. 18 is just one example of a method, and other methods including fewer, additional, or alternative operations are possible consistent with this disclosure.

### Example Computing Device for Comprehensive Writing Enhancement

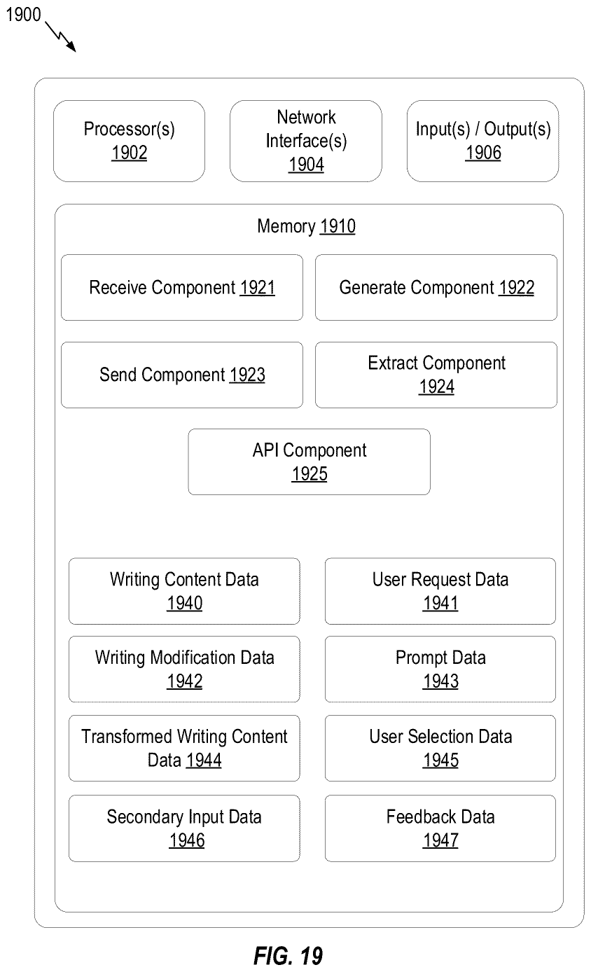

FIG. 19 schematically depicts an example computing device 1900 for enabling a writing enhancement system for providing comprehensive writing enhancement for improving writing according to one or more aspects shown and described herein.

The computing device 1900 includes one or more processors 1902. Generally, processor(s) 1902 may be configured to execute computer-executable instructions (e.g., software code) to perform various functions, as described herein.

The computing device 1900 further includes a network interface(s) 1904, which generally provides data access to any sort of data network, including personal area networks (PANs), local area networks (LANs), wide area networks (WANs), the Internet, and the like.

The computing device 1900 further includes input(s) and output(s) 1906, which generally provide means for providing data to and from the computing device 1900, such as via connection to computing device peripherals, including user interface peripherals.

The computing device 1900 further includes a memory 1910 configured to store various types of components and data.

In this example, memory 1910 includes a receive component 1921, a generate component 1922, a send component 1923, an extract component 1924, and an API component 1925.

Receive component 1921 may be configured to perform processes, for example, corresponding to blocks 1802, 1804, and 1810 of method 1800 depicted and described with reference to FIG. 18.

Generate component 1922 may be configured to perform processes, for example, corresponding to block 1806 of the method 1800 depicted and described with reference to FIG. 18.

Send component 1923 may be configured to perform processes, for example, corresponding to blocks 1808 and 1812 of method 1800 depicted and described with reference to FIG. 18.

Extract component 1924 may be configured to perform processes for extracting certain writing content, for example, corresponding to illustrative processes 300-1100 depicted and described with reference to FIGS. 3-11.

API component 1925 may be configured to perform processes for performing API calls to interact with a language model, for example, corresponding to illustrative processes 300-1100 depicted and described with reference to FIGS. 3-11.

In this example, memory 1910 also includes writing content data 1940, user request data 1941, writing modification indication data 1942, prompt data 1943, transformed writing content data 1944, user selection data 1945, secondary input data 1946, and feedback data 1947.

The computing device 1900 may be implemented in various ways. For example, the computing device 1900 may be implemented within on-site, remote, or cloud-based computing devices.

The computing device 1900 is just one example, and other configurations are possible. For example, in alternative embodiments, aspects described with respect to the computing device 1900 may be omitted, added, or substituted for alternative aspects.

### Example Clauses

Implementation examples are described in the following numbered clauses:
Clause 1: A method of enhancing writing content includes: receiving, from a document editing application, a user request to transform writing content and an indication of a modification for improving the writing content; receiving, from the document editing application, the writing content associated with the user request; generating, based on the user request and the writing content, a prompt for improving the writing content based on the indication of the modification; sending, to a language model, the prompt; receiving, from the language model, based on the prompt, transformed writing content; and sending, to the document editing application, the transformed writing content.
Clause 2: The method of Clause 1, further including: receiving, a second user selection corresponding to accepted transformed writing content; receiving user feedback based on the accepted transformed content; and storing the user feedback and the second user selection in a storage component.
Clause 3: The method of Clause 2, wherein generating, based on the user request and the writing content, a prompt for improving the writing content based on the indication of the modification further includes: extracting one or more work experience excerpts from the writing content; and generating the prompt further based on the one or more work experience excerpts.
Clause 4: The method of any one of Clauses 1-3, further including performing region-based reformatting of the transformed writing content; generating suggested synonyms for words in the transformed writing content; and sending the suggested synonyms for the words in the transformed writing content to a user.

Clause 5: The method of Clause 2, wherein generating, based on the user request and the writing content, the prompt for improving the writing content based on the indication of the modification further includes: receiving, from a user, one or more secondary inputs; and generating the prompt further based on the one or more secondary inputs.

Clause 6: The method of any of Clauses 1, 2, or 5, wherein the one or more secondary inputs comprise a user selected relevant industry, a user selected desired tone, and a user selected word limit, and the modification for improving the writing content comprises rephrasing the writing content based on the secondary inputs.

Clause 7: The method of any of Clauses 1, 2, or 5, wherein the one or more secondary inputs comprise a user selected job title and one or more user selected work experience excerpts, and the modification for improving the writing content comprises generating a set of enhanced work experience excerpts corresponding to the one or more user selected work experience excerpts and based on the writing content and the secondary inputs.

Clause 8: The method of any of Clauses 1, 2, or 5, wherein the one or more secondary inputs comprise user selected skills; and the modification for improving the writing content comprises generating alternative skills based on the writing content and the secondary inputs.

Clause 9: The method of any of Clauses 1, 2, or 5, wherein the one or more secondary inputs comprise one or more user selected summaries, and the modification for improving the writing content comprises generating alternative summaries based on the writing content and the secondary inputs.

Clause 10: The method of any of Clauses 1, 2, or 5, wherein the one or more secondary inputs comprise user selected work experience excerpts, and the modification for improving the writing content comprises inserting one or more power words into the writing content based on the writing content and the secondary inputs.

Clause 11: The method of any of Clauses 1, 2, or 5, wherein the one or more secondary inputs comprise one or more user selected work experience excerpts, and the modification for improving the writing content comprises removing one or more redundancies in the writing content based on the writing content and the secondary inputs.

Clause 12: The method of any of Clauses 1, 2, or 5, wherein the one or more secondary inputs comprise a work history section, and the modification for improving the writing content comprises re-ordering one or more excerpts within the writing content according to a set of prioritization rules in the generated prompt, and based on the writing content and the secondary inputs.

Clause 13: The method of any of Clauses 1, 2, or 5, wherein the one or more secondary inputs comprise one or more user selected work experience excerpts, and the modification for improving the writing content comprises modifying tenses of the writing content based on the writing content and the secondary inputs.

Clause 14: A method for improving writing content including: receiving, from a document editing application, a resume; receiving, from the document editing application, a user request to transform writing content, and an indication of a modification for improving the writing content; extracting, from the resume, the writing content; generating, based on the user request, the indication of the modification, and the extracted writing content, a prompt for improving the writing content based on the indication of the modification; sending the prompt to a language model; receiving, from the language model, based on the prompt, transformed writing content; and sending, to the document editing application, the transformed writing content.

Clause 15: A processing system, comprising means for performing a method in accordance with any one of Clauses 1, 2, 5, or 14.

Clause 16: A non-transitory computer-readable medium comprising computer-executable instructions that, when executed by one or more processors of a processing system, cause the processing system to perform a method in accordance with any one of Clauses 1, 2, 5, or 14.

Clause 17: A computer program product embodied on a computer-readable storage medium comprising code for performing a method in accordance with any one of Clauses 1, 2, 5, or 14.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of enhancing writing content, the method comprising:
receiving, from a document editing application, a user request to transform writing content and an indication of a modification for improving the writing content;
receiving, from the document editing application, the writing content associated with the user request;
generating, based on the user request and the writing content, a prompt for improving the writing content based on the indication of the modification;
sending, to a language model, the prompt;
receiving, from the language model, based on the prompt, transformed writing content; and
sending, to the document editing application, the transformed writing content.

2. The method of claim 1, further comprising:
receiving, a second user selection corresponding to accepted transformed writing content;
receiving user feedback based on the accepted transformed writing content; and
storing the user feedback and the second user selection in a storage component.

3. The method of claim 1, wherein generating, based on the user request and the writing content, the prompt for improving the writing content based on the indication of the modification further comprises:
extracting one or more work experience excerpts from the writing content; and
generating the prompt further based on the one or more work experience excerpts.

4. The method of claim 3, further comprising:
performing region-based reformatting of the transformed writing content;
generating suggested synonyms for words in the transformed writing content; and
sending the suggested synonyms for the words in the transformed writing content to a user.

5. The method of claim 1, wherein generating, based on the user request and the writing content, the prompt for improving the writing content based on the indication of the modification further comprises:
receiving, from a user, one or more secondary inputs; and
generating the prompt further based on the one or more secondary inputs.

6. The method of claim 5, wherein:
the one or more secondary inputs comprise a user-selected relevant industry, a user-selected desired tone, and a user-selected word limit, and
the modification for improving the writing content comprises rephrasing the writing content based on the secondary inputs.

7. The method of claim 5, wherein:
the one or more secondary inputs comprise a user-selected job title and one or more user-selected work experience excerpts, and
the modification for improving the writing content comprises generating a set of enhanced work experience excerpts corresponding to the one or more user-selected work experience excerpts and based on the writing content and the secondary inputs.

8. The method of claim 5, wherein:
the one or more secondary inputs comprise user-selected skills; and
the modification for improving the writing content comprises generating alternative skills based on the writing content and the secondary inputs.

9. The method of claim 5, wherein:
the one or more secondary inputs comprise one or more user-selected summaries, and
the modification for improving the writing content comprises generating alternative summaries based on the writing content and the secondary inputs.

10. The method of claim 5, wherein:
the one or more secondary inputs comprise user-selected work experience excerpts, and
the modification for improving the writing content comprises inserting one or more power words into the writing content based on the writing content and the secondary inputs.

11. The method of claim 5, wherein:
the one or more secondary inputs comprise one or more user-selected work experience excerpts, and
the modification for improving the writing content comprises removing one or more redundancies in the writing content based on the writing content and the secondary inputs.

12. The method of claim 5, wherein:
the one or more secondary inputs comprise a work history section, and
the modification for improving the writing content comprises re-ordering one or more excerpts within the writing content according to a set of prioritization rules in the generated prompt, and based on the writing content and the secondary inputs.

13. The method of claim 5, wherein:
the one or more secondary inputs comprise one or more user-selected work experience excerpts, and
the modification for improving the writing content comprises modifying tenses of the writing content based on the writing content and the secondary inputs.

14. A processing system for improving writing content, comprising:
one or more memories comprising computer-executable instructions; and
one or more processors configured to execute the computer-executable instructions causing the processing system to:
receive, from a document editing application, a user request to transform writing content and an indication of a modification for improving the writing content;
receive, from the document editing application, the writing content associated with the user request;
generate, based on the user request and the writing content, a prompt for improving the writing content based on the indication of the modification for improving the writing content;
send, to a language model, the prompt;
receive, from the language model, based on the prompt, transformed writing content; and
send, to the document editing application, the transformed writing content.

15. The processing system of claim 14, wherein the one or more processors are further configured to cause the processing system to:
receive, a second user selection corresponding to accepted transformed writing content;
receive user feedback based on the accepted transformed writing content; and
store the user feedback and the second user selection in a storage component.

16. The processing system of claim 14, wherein to generate, based on the user request and the writing content, the prompt for improving the writing content based on the modification, the one or more processors are further configured to cause the processing system to:
extract one or more work experience excerpts from the writing content; and
generate the prompt further based on the one or more work experience excerpts.

17. The processing system of claim 14, wherein the one or more processors are further configured to cause the processing system to:
perform region-based reformatting of the transformed writing content;
generate suggested synonyms for words in the transformed writing content; and
send the suggested synonyms for the words in the transformed writing content to a user.

18. The processing system of claim 14, wherein to generate, based on the user request and the writing content, the prompt for improving the writing content based on the indication of the modification for improving the writing content, the one or more processors are further configured to cause the processing system to:
receive, from a user, one or more secondary inputs; and
generate the prompt further based on the one or more secondary inputs.

19. The processing system of claim 18, wherein:
the one or more secondary inputs comprise a user-selected relevant industry, a user-selected desired tone, and a user-selected word limit, and
the modification for improving the writing content comprises rephrasing the writing content based on the secondary inputs.

20. A method for enhancing writing content comprising:
receiving, from a document editing application, a resume;
receiving, from the document editing application, a user request to transform writing content, and an indication of a modification for improving the writing content;
extracting, from the resume, the writing content;
generating, based on the user request, the indication of the modification, and the extracted writing content, a prompt for improving the writing content based on the indication of the modification;
sending the prompt to a language model;
receiving, from the language model, based on the prompt, transformed writing content; and
sending, to the document editing application, the transformed writing content.
